(19) United States
(12) Patent Application Publication
(10) Pub. No.: US 2018/0019034 A1
(43) Pub. Date: Jan. 18, 2018

(54) PRODUCTION OF N-13 AMMONIA RADIONUCLIDE

(71) Applicant: Global Medical Isotope Systems LLC, Henderson, NV (US)

(72) Inventor: Francis Y. Tsang, Las Vegas, NV (US)

(21) Appl. No.: 15/648,330

(22) Filed: Jul. 12, 2017

Related U.S. Application Data
(60) Provisional application No. 62/361,758, filed on Jul. 13, 2016.

(51) Int. Cl. G21G 1/12; C01C 1/04; G21G 1/00; H05G 2/00

(52) U.S. Cl. CPC G21G 1/12; H05G 2/00; C01C 1/0411; G21G 1/001; G21G 2001/0094

(57) ABSTRACT

A method of producing ¹³N-ammonia for use in medical imaging is provided, which includes irradiating ¹⁴N (having a natural abundance of 99.64%) with a collimated bremsstrahlung radiation (gamma-ray beam) obtained by directing high-energy electrons onto a high-Z converter. The ¹⁴N to be irradiated may be in the form of liquid ammonia (¹⁴NH₃) or ammonia gas to directly produce ¹³N-ammonia (¹³NH₃) or in the form of liquid nitrogen to indirectly produce ¹³N-ammonia through conversion of the irradiated liquid nitrogen (N₂) via known conversion processes to ¹³N-ammonia. The photons have an energy level above the threshold of the ¹⁴N(γ,n)¹³N reaction (about 10.5 MeV).

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

The present disclosure relates generally to the generation of unstable, i.e., radioactive, nuclear isotopes, and more particularly to a system and method for generating the medical radionuclide nitrogen-13 (¹³N) via the gamma-ray-induced isotopic reaction, ¹⁴N(γ,n)¹³N.

Nitrogen-13 (¹³N), used in the form of the tracer ¹³N-ammonia (NH₃), is a valuable positron-emitting radionuclide commonly used for cardiac positron emission tomography (PET) imaging of the myocardium under rest or pharmacologic stress conditions to evaluate myocardial perfusion in patients with suspected or existing coronary artery disease or small-vessel disease. ¹³N-ammonia can also be utilized to measure blood flow in other parts of the body, such as the liver, kidney, brain and malignant tumors.

When used for cardiac PET imaging, the ¹³N diffuses rapidly from the blood into myocardial cells. Some of the ¹³N-ammonia is synthesized into ¹³N-glutamine and becomes metabolically trapped in the myocardium. Since the myocardial uptake is proportional to the blood flow, ¹³N-ammonia is a good myocardial perfusion agent for the detection of coronary artery disease.

¹³N-ammonia has a short half-life (9.97 minutes) and decays by positron emission (100%) resulting in the production of two (2) 511 keV gamma-rays via the annihilation process.

One method that has been used to produce the ¹³N used in nuclear medicine utilizes the ¹⁶O(p,α)¹³N nuclear reaction via proton irradiation of ¹⁶O. Another method involves irradiation of H₂O in the presence of 5-10 millimolar ethanol by protons from cyclotrons having energies greater than 11 MeV. The proton bombardment produces ¹³N-ammonia as the major radionuclide, but also ¹⁵O by the ¹⁶O(p,pn)¹⁵O nuclear reactions. The ¹³N-ammonia is held for 10 minutes which allows the ¹⁵O (half-life 2.04 minutes) to decay to less than 5% by time of delivery. Trace amounts of (¹⁸F) fluoride ions are also produced from the 0.2% naturally occurring ¹⁸O-water by the ¹⁸O(p,n)¹⁸F nuclear reactions. These traces of fluoride ions are removed by the anion exchange resin used for purification of ¹³N-ammonia. A half-life measurement is performed for each batch of ¹³N-ammonia, which results in a measurement between 9.5-10.5 min. Other production methods and additional details are described in Hell J Nucl Med 2009; 12(3): 248-250, which is incorporated herein by reference.

Due to the short half-life of ¹³N, it is not possible to stock-pile the ¹³N, so a large quantity of ¹³N has to be produced with expensive cyclotrons using the current production methods. Several large production facilities currently are regionally dispersed to serve patients in all areas of the country. However, cyclotrons not only have huge initial setup cost, but also are expensive to maintain and operate. Accordingly, there is a need for a method for producing ¹³N-ammonia that utilizes a very inexpensive, on-demand production system and thereby eliminates the need for large and expensive cyclotron facilities.

### SUMMARY

The present disclosure is directed to a system and method for the production of ¹³N-ammonia from nitrogen-14 (¹⁴N) that includes loading a ¹⁴N target into an irradiation chamber, using an incident beam of electrons impinging on a high-Z material to produce an intense collimated bremsstrahlung (photon beam) and directing the intense collimated photon beam to irradiate the ¹⁴N target. ¹³N is produced through the ¹⁴N(γ,n)¹³N nuclear reaction.

Methods for producing ¹³N-ammonia are disclosed. In the first, the ¹⁴N of the ¹⁴N target may be in the form of liquid ammonia or ammonia gas, which is directly irradiated to form ¹³N-ammonia. In the second, the ¹⁴N target may be in the form of liquid nitrogen (N₂), with the ¹³N produced then converted to ¹³N-ammonia via a conventional synthesis process, such as the Haber process.

In contrast to the production of ¹³N-ammonia through the ¹⁶O(p,α)¹³N nuclear reaction using a cyclotron to accelerate charged particles, the method of the instant disclosure utilizes high energy photons to produce ¹³N-ammonia and so does not require a cyclotron. Instead, a compact electron accelerator introduces the required energy into the system by generating an incident beam of high energy electrons impinging onto a high-Z material to produce an intense photon beam. Compact electron accelerators are much less expensive than cyclotrons to procure,—to install, and to maintain and operate.

Electrons impinging on the high-Z converter target generates photons to form the gamma-ray beam. Preferably the energy of most of the photons generated is above the threshold of the ¹⁴N(γ,n)¹³N nuclear reaction, which is about 10.5 MeV. In some embodiments, the photons generated can have an energy up to about 30 MeV. In some embodiments, the photons generated can have an energy up to about 25 MeV or up to about 20 MeV. In some embodiments, photons having an energy in the range of about 10.5 MeV to about 30 MeV, about 10.5 MeV to about 25 MeV, or about 10.5 MeV to about 20 MeV can create the isotope ¹³N, while avoiding the production of undesirable isotopes.

The production of ¹³N from the ¹⁴N(γ,n)¹³N reaction is shown in the graph of FIG. 1 (from the Handbook on Photonuclear Data for Applications: Cross-Sections and Spectra, IAEA-TECDOC-1178, IAEA, 2000, page 100). This graph shows that significant amounts of ¹³N are produced even if the impinging gamma-ray beam has an energy of under 25 MeV.

An object of the present disclosure is to provide a system and method that produces ^{—}N-ammonia used in nuclear medicine.

An additional object of the present disclosure is to provide a ^{—}N-ammonia production system and method that produces the medical isotope ¹³N without the usage of a cyclotron.

These and other objects, features, and advantages of the present disclosure will become more readily apparent from the attached drawings and from the detailed description of the embodiments which follow.

### BRIEF DESCRIPTION OF THE DRAWINGS

Embodiments of the disclosure will hereinafter be described in conjunction with the appended drawings, provided to illustrate and not to limit the disclosure, where like designations denote like elements.

FIG. 1 is a graph showing the cross-section of the ¹⁴N(γ,n)¹³N reaction of the current disclosure versus incident photon energy.

FIG. 2 is a graph showing the cross-section of ¹⁴N(γ,px) reactions, which includes a competing reaction ¹⁴N(γ,p)¹³C having a threshold at about 7.5 MeV.

FIG. 3 is a conceptual diagram (not to scale) of the system of the present disclosure for producing ¹³N through use of a collimated photons that irradiates a target such as liquid ammonia, ammonia gas, or liquid nitrogen to produce ¹³N through the ¹⁴N(γ,n)¹³N reaction.

FIG. 4 is a flowchart summarizing the ¹³N-ammonia production method in which liquid ammonia or ammonia gas is irradiated to create ¹³N from the ¹⁴N(γ,n)¹³N reaction of the current disclosure.

FIG. 5 is a flowchart summarizing the ¹³N-ammonia production method in which liquid nitrogen is irradiated to create ¹³N from the ¹⁴N(γ,n)¹³N reaction of the current disclosure.

Like reference numerals refer to like parts throughout the several views of the drawings.

### DETAILED DESCRIPTION

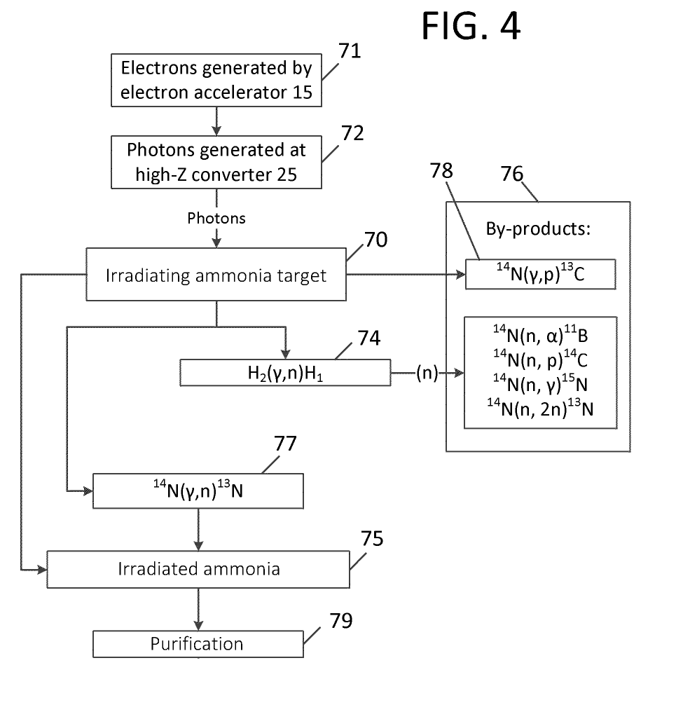

The present disclosure is directed to a system and method for the production of ¹³N-ammonia (¹³NH₃) by converting nitrogen-14 (¹⁴N) to nitrogen-13 (¹³N) utilizing the ¹⁴N(γ,n)¹³N reaction. Some embodiments are directed to a first method for producing ¹³NH₃ through direct irradiation of liquid ammonia or ammonia gas (FIG. 4). Some embodiments are directed to a second method for producing ¹³NH₃ through irradiation of liquid nitrogen and conversion of irradiated liquid nitrogen to ¹³N-ammonia through conventional chemical processes, such as via the Haber process.

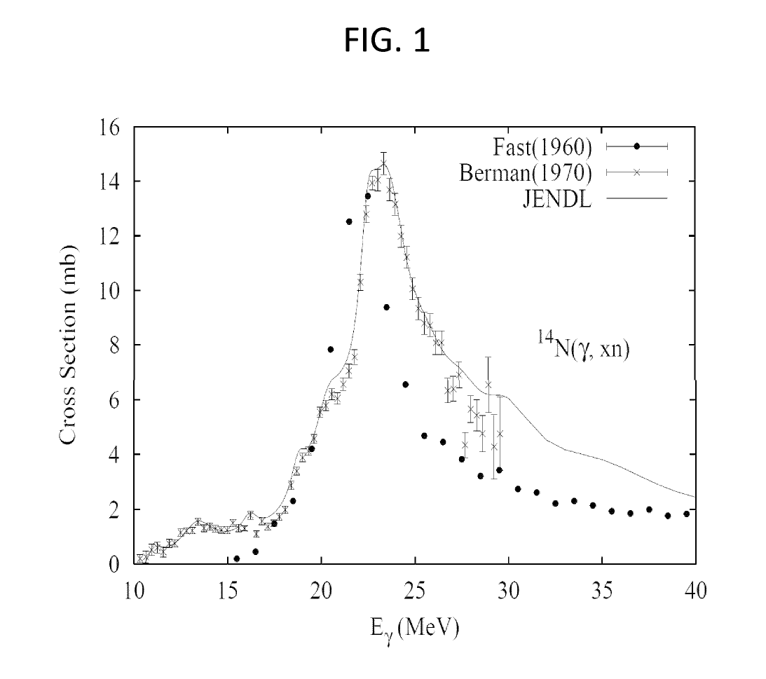

FIG. 1 shows the cross-section (in millibarns) of the photon-induced ¹⁴N(γ,n)¹³N reaction versus the photon energy (in MeV). The ¹⁴N(γ,n)¹³N reaction has a photon threshold energy at about 10.5 MeV and reaches a photon cross-section value of about 14.5 millibarns at 22 MeV.

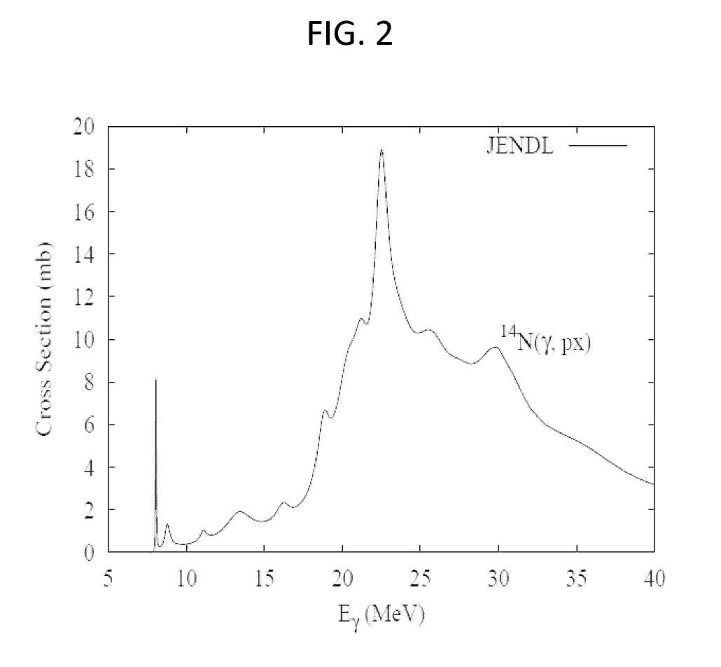

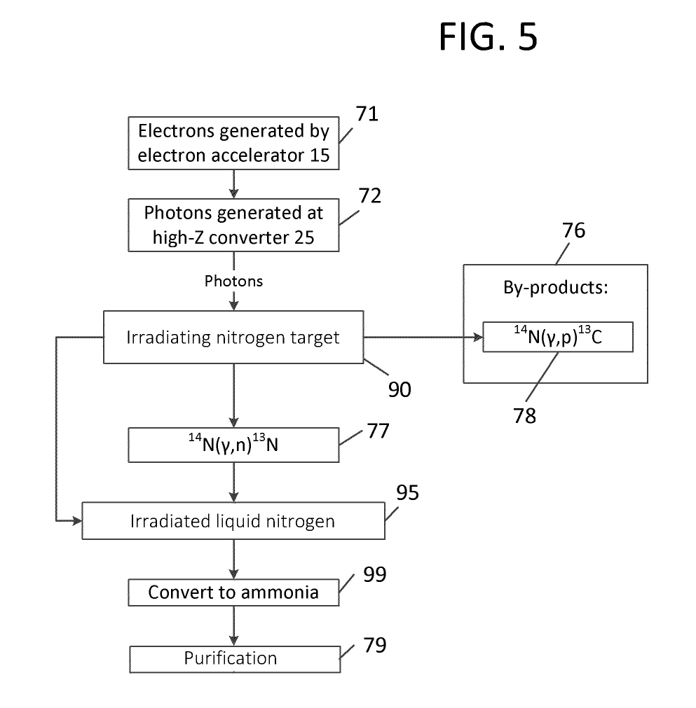

FIG. 2 shows the reaction cross-section plot for ¹⁴N(γ,px) reactions, which includes a competing reaction ¹⁴N(γ,p)¹³C having a threshold at about 7.5 MeV. This competing reaction produces the by-product ¹³C (step 76 in FIGS. 4-5), but since carbon is insoluble in either liquid ammonia or liquid nitrogen any traces of the ¹³C from this competing reaction can be easily and safely removed. This ¹³C removal may be by micro-filtration in the case of liquid ammonia or may be left behind as a residue after the nitrogen gas is evaporated before the conversion of the nitrogen gas to ammonia.

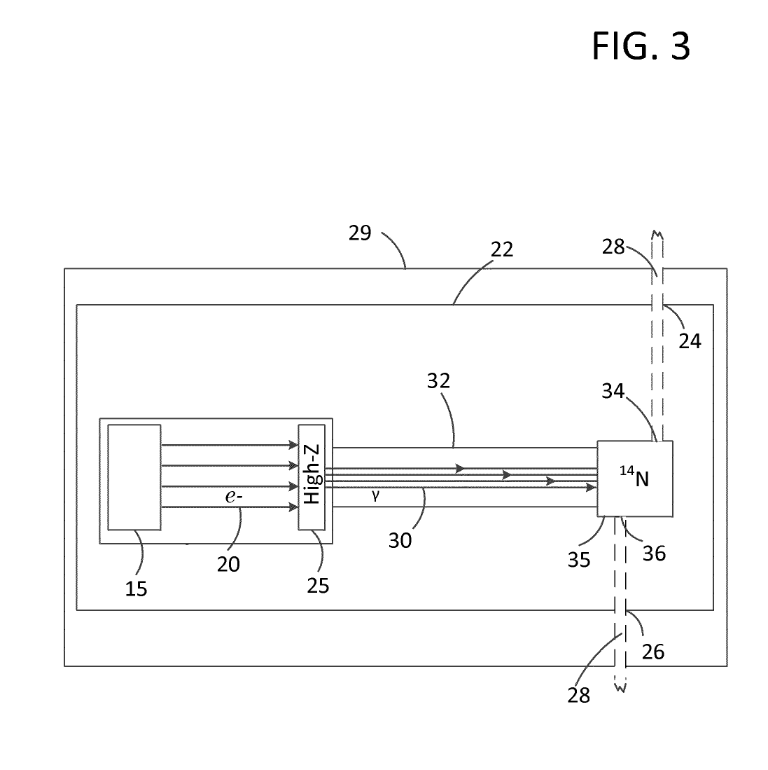

FIG. 3 depicts an embodiment of the system for the production of ¹³N-ammonia (¹³NH₃). An electron accelerator 15 produces an electron beam 20 that is directed onto a high-Z converter 25. In some embodiments, the electron accelerator 15 and high-Z converter 25 may be disposed within a vacuum system. The impinging electrons produce an intense collimated bremsstrahlung (gamma-ray) radiation 30 that is emitted from the high-Z converter 25 into a ¹⁴N target in the sample holder 35. In some embodiments, the ¹⁴N target may be liquid ammonia or ammonia gas. In other embodiments, the ¹⁴N target may be liquid nitrogen.

The electron accelerator 15 is a compact, high-power electron accelerator that generates an electron beam 20 with electrons having an energy above about 10.5 MeV, which is the photon energy threshold of the ¹⁴N(γ,n)¹³N reaction. In some embodiments, the electrons may have an energy up to about 30 MeV. The intensities of the bremsstrahlung spectra produced by this type of relativistic electron beam are all forward-peaking and sometimes referred to as a “radiation cone,” which is the collimated photon (gamma-ray) beam 30 in FIG. 3. In the production methods of the current disclosure, the radiation cone of the bremsstrahlung spectrum (i.e., collimated gamma-ray beam 30) is directed toward and irradiates the sample holder 35 containing the ammonia or nitrogen target to activate the ¹³N within the liquid ammonia, ammonia gas, or liquid nitrogen.

The appropriate electron accelerator 15 is chosen based on considerations of economics and technical requirements for successful process implementation. For example, a suitable electron accelerator is the Varian CLINAC 2100C high energy electron linear accelerator, having an energy of about 30 MeV, which can deliver about 125 Gray of radiation per minute while delivering an electron current >1 milliamp.

The high-Z converter 25 is placed in the path of the incident electron beam 20 to convert the relativistic electrons via the (e−,γ) reaction with the photon maximum energy roughly equal to the maximum incident electron energy. Although any of a number of high-Z materials may be used, exemplary high-Z materials are uranium (U), tantalum (Ta), and tungsten (W). The high-Z converter 25 may be in a solid form (such as a plate or sheet), may be multiple solid pieces (such as multiple sheets), or may be in the form of a mesh or matrix array of material. The conversion (production) efficiency of bremsstrahlung for electrons with a thin high-Z converter and energy of about 30 MeV is about 70%. About 30% of the produced high energy photons (or hard x-rays, or gamma-rays) are contained within a narrow solid angle of about 5 steradians.

The target sample holder 35 may be configured to receive a predetermined volume of the liquid ammonia or ammonia gas to be irradiated. In some embodiments, the liquid ammonia may be anhydrous liquid ammonia. The sample holder 35 preferably is positioned within the narrow solid angle of about 5 steradians of the forward-peaking bremsstrahlung cone of photons. In some embodiments, a 3 cc vial may be used to hold the target, but vials of other sizes can also be used. Optionally, in some embodiments, input/output piping 28 may be included to allow introduction and extraction of the target material into and out of the sample holder 35.

With reference to FIG. 3, the electron accelerator components 15, the high-Z converter material 25, and the target sample holder 35 are disposed in the irradiation chamber 22. In some embodiments, the electron accelerator components 15 and the high-Z converter material 25 may optionally be disposed within a vacuum system inside of the irradiation chamber 22. Optionally, input/output piping 28 may be installed by routing it from an irradiation chamber inlet 24 to an inlet 34 into the sample holder 35 and by routing it from an outlet 36 of the sample holder 35 to an outlet 26 in the irradiation chamber. Optionally, one or more internal reflectors 32 may be installed within the irradiation chamber 22, such as to enhance the collimation of the gamma-rays. In some embodiments, a biological shield 29 may also be installed outside the irradiation chamber 22.

In some embodiments, the cross-sectional area of the sample holder 35 is 1 cm²; the length is 3 cm; and the volume is 3 cc. Using this configuration and the output from the electron accelerator of 1 milliampere of current, the output of the system would be 6.24×10¹⁵ electrons/second. The photon flux (the number of photons above 10 MeV/cm²/second) produced from a 25 MeV electron beam using a converter imparting onto a sample with a cross sectional area of 1 cm² that is placed at a distance of 1 meter from the converter is equal to (0.7)×(0.3)×(0.1)×(6.24×10¹⁵) photons/cm²/second, which is 1.3×10¹⁴ photons/cm²/second. Since the ¹⁴N(γ,n)¹³N nuclear reaction cross-section has an average of about 10 millibarns between 10 MeV and 25 MeV, the total number of ¹³N nuclei that could be produced in one second within the liquid ammonia sample is equal to [(photon flux)×(density)×(Avogadro number)×(reaction cross-sections)×(thickness of sample)×(atomic weight)], which equals to about 1×10^{11 13}N nuclei produced per sec. Therefore, 7.2×10^{10 13}N nuclei can be produced in 1 second with a 1 mA, 25 MeV electron beam through a thin high-Z converter (such as 4 mm Tungsten) with a sample holder 35 that is 3 cm long with a cross-sectional area of 1 cm², placed at 1 meter away from the converter.

FIG. 4 is a flowchart showing steps involved in the first method of production of the ¹³N-ammonia radionuclide using an ammonia target. The ammonia target may be liquid ammonia or ammonia gas. In some embodiments, the liquid ammonia may include anhydrous liquid ammonia. In some embodiments, the ammonia target contains >99% of ¹⁴NH₃. The ammonia target may be made or purchased. In some embodiments, the ammonia gas target may be made by reaction Devarda's alloy as a reducing agent with nitrate solution under alkaline conditions. The produced ammonia gas can be irradiated directly or can be condensed (and optionally compressed) into a liquid form for use in direct irradiation.

Electrons are generated (step 71) by the electron accelerator components 15 as shown in FIG. 3. This high energy electron beam 20 impinges the high-Z converter target 25 to generate photons (step 72) that form an intense collimated gamma-ray beam 30. This gamma-ray radiation cone irradiates the ammonia target contained within the sample holder 35 (step 70). The nitrogen isotope in the ammonia target is substantially all ¹⁴N, as ¹⁴N has a natural abundance of 99.64%. Some of the nitrogen atoms within the ammonia target are activated, with ¹⁴N converted to ¹³N (step 77), which results in irradiated ammonia that has both ¹⁴N and ¹³N atoms (i.e., ¹³NH₃ and ¹⁴NH₃) (step 75).

The irradiated ammonia (having a portion of the nitrogen being ¹⁴N and a portion being ¹³N) is removed from the nitrogen target sample holder 35. In embodiments where ammonia gas is used as ammonia target, the irradiated ammonia gas can be converted to irradiate liquid ammonia by further passing through a condenser. In some embodiments, the irradiated ammonia gas can also pass through a condenser and a compressor.

In some embodiments, the irradiated liquid ammonia can undergo a purification process (step 79), where it is filtered, purified and prepared (step 79) for use. The purified ammonia is packaged and transported to the location of use, which is usually within the same facility, due to the short half-life of ¹³N. In some embodiments, before or after transporting, the liquid ammonia is diluted to an appropriate volume with a sodium solution. Once the dose rate is checked, the dose of ¹³N-ammonia can be administered to the patient.

By-products are formed by the competing reaction ¹⁴N(γ,p)¹³C 78 and from neutrons generated from deuterium (step 76). Though deuterium has only a 0.01% natural abundance, its low photoneutron threshold of 2.22 MeV makes it an important potential neutron source when liquid ammonia is used to produce ¹³N-ammonia. The photoneutrons produced through the ²H(γ,n)¹H nuclear reaction 74 will interact with the ¹⁴N atoms via the following nuclear reactions: ¹⁴N(n,α)¹¹B, ¹⁴N(n,p)¹⁴C; ¹⁴N(n,γ)¹⁵N; and ¹⁴N(n,2n)¹³N. The ¹⁴N(n,α)¹¹B has a threshold at about 1 MeV and produces ¹¹B. The ¹⁴N(n,p)¹⁴C nuclear reaction also has a low threshold and has a cross-section equivalent to the cross-section of the ¹⁴N(n,α)¹¹B reaction at 1 MeV. However, both ¹¹B and ¹⁴C are insoluble in liquid ammonia, so these impurities can be removed by micro-filtration in the purify and prepare operation of step 79. The ¹⁴N(n,γ)¹⁵N nuclear reaction produces ¹⁵N, which is a stable isotope of nitrogen that does not affect the chemical and physical properties of ¹³N-ammonia, so removal of ¹⁵N is unnecessary. The ¹⁴N(n,2n)¹³N nuclear reaction produces ¹³N, which is the desired isotope, and thus it will merely aid in producing a higher concentration of the desirable ¹³N-ammonia product.

FIG. 5 is a flowchart showing the steps involved in the second method of production of the ¹³N-ammonia radionuclide using liquid nitrogen. As in the first method, high energy electrons are generated by the electron accelerator components 15 (step 71) as shown in FIG. 3, which impinge the high-Z target 25 to generate photons (step 72) that form an intense collimated gamma-ray beam 30. This gamma-ray radiation cone irradiates the liquid nitrogen contained within the sample holder 35 (step 90). A substantial portion of the ¹⁴N of the liquid nitrogen is converted to ¹³N within the ¹⁴N liquid nitrogen (step 77), which results in irradiated liquid nitrogen (step 95) that has both ¹⁴N and ¹³N atoms.

The irradiated liquid nitrogen (step 95) (including ¹⁴N and ¹³N) is removed from the sample holder 35, and then converted to liquid ammonia (step 99). In some embodiments, conversion of liquid nitrogen to liquid ammonia in step 99 may be accomplished using the Haber process. The liquid nitrogen (from step 95) is converted to nitrogen gas, and then combined with hydrogen gas in 1:3 ratio by volume. The gas mixture is compressed and introduced into a reaction chamber, where the reaction takes place at a temperature of about 400 to about 450° C., a pressure of about 200 to about 250 atm, and in the presence of a catalyst. The catalyst may be osmium, platinum, iron (such as prepared by reducing magnetite (Fe₃O₄)), or ruthenium-based catalyst or other known Haber catalyst. After the reaction, the resultant gas is cooled and condensed into liquid ammonia. In some embodiments, the resultant ammonia gas may also be compressed during the process of conversion to liquid ammonia.

In some embodiments, the resultant liquid ammonia can undergo a purification process (step 79), where it is filtered, purified and prepared for use. The purified ammonia is packaged and transported to the location of use, which is usually within the same facility, due to the short half-life of ¹³N. In some embodiments, before or after transporting, the liquid ammonia is diluted to an appropriate volume with a sodium solution. Once the dose rate is checked, the dose of ¹³N-ammonia can be administered to the patient.

In this second production method depicted in FIG. 5, a lesser amount of by-products are formed (step 76) than in the first method, because no hydrogen atoms are present when the nitrogen target is irradiated.

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the disclosure should be determined by the appended claims and their legal equivalents.

What is claimed is:

1. A method of producing ¹³N-ammonia via an isotopic conversion reaction comprising:
providing a target having nitrogen atoms that are substantially ¹⁴N, wherein the target is ammonia or nitrogen;
directing high-energy electrons onto a high-Z converter to produce a collimated gamma-ray beam; and
directing said collimated gamma-ray beam to irradiate said ammonia target or nitrogen target to convert at least a portion of the ¹⁴N to ¹³N isotope, thereby forming an irradiated ammonia or irradiated nitrogen.

2. The method of claim 1, wherein said high-energy electrons have an energy level above the threshold of a ¹⁴N(γ,n)¹³N reaction.

3. The method of claim 1, wherein said high-energy electrons have an energy level up to about 30 MeV.

4. The method of claim 1, wherein said high-Z converter is uranium, tantalum, or tungsten.

5. The method of claim 1, further comprises purifying irradiated ammonia.

6. The method of claim 1, wherein the target is liquid ammonia or ammonia gas.

7. The method of claim 6, wherein the target is anhydrous liquid ammonia.

8. The method of claim 1, wherein the target is liquid nitrogen.

9. The method of claim 8, wherein further comprising converting said irradiated nitrogen to irradiated ammonia.

10. The method of claim 9, further comprises purifying irradiated ammonia.

11. A method of producing ¹³N-ammonia via an isotopic conversion reaction comprising:
providing a liquid nitrogen target comprising ¹⁴N atoms;
directing high-energy electrons onto a high-Z target to produce a collimated gamma-ray beam;
directing said collimated gamma-ray beam to irradiate said liquid nitrogen target to isotopically convert the liquid nitrogen target to an irradiated liquid nitrogen having at least a portion of said ¹⁴N atoms converted to a ¹³N isotope; and
converting said resulting irradiated liquid nitrogen to ¹³N-ammonia (¹³NH₃).

12. The method of claim 11, wherein said high-energy electrons have an energy level above the threshold of said ¹⁴N(γ,n)¹³N reaction.

13. The method of claim 11, wherein said high-energy electrons have an energy level below about 30 MeV.

14. The method of claim 11, wherein said high-Z converter target is one of uranium, tantalum, or tungsten.

15. The method of claim 11, wherein said converting said irradiated liquid nitrogen to said ¹³N-ammonia comprises utilizing the Haber process.

16. The method of claim 15, wherein said Haber process comprises a Haber reaction combining said irradiated liquid nitrogen in the form of nitrogen gas (N₂) with hydrogen gas (H₂) in the presence of a catalyst at a temperature of about 400 to about 500° C. and at a pressure of about 175 to about 250 atmospheres.

17. The method of claim 16, wherein said catalyst is selected from the group consisting of osmium catalyst, platinum catalyst, ruthenium catalyst, and iron catalyst.
